(19) United States
(12) Patent Application Publication
(10) Pub. No.: US 2006/0018528 A1
(43) Pub. Date: Jan. 26, 2006

(54) Imaging, diagnostic, and therapeutic devices and methods of use thereof

(75) Inventors: John E. Pandolfino, Chicago, IL (US); Guoxiang Shi, Park Ridge, IL (US); Bryan Trueworthy, Chicago, IL (US); Peter J. Kahrilas, Park Ridge, IL (US); Marvin P. Loeb, Huntington Beach, CA (US)

Correspondence Address: Medlen & Carroll, LLP, Suite 350, 101 Howard Street, San Francisco, CA, 94105, US

(73) Assignee: Northwestern University, Evanston, IL (US)

(21) Appl. No.: 11/115,511

(22) Filed: Apr. 27, 2005

Related U.S. Application Data
(60) Provisional application No. 60/565,769, filed on Apr. 27, 2004.

(51) Int. Cl. G06K 9/00

(52) U.S. Cl. 382/133

(57) ABSTRACT

The present invention relates to devices and methods for imaging, characterizing, diagnosing, monitoring a treatment, and treating junctions between internal body areas. In particular, the devices of the present invention are useful in distinguishing normal, non-hernia, reflux, and hernia patients for diagnostic purposes, drug screening, and selecting and monitoring appropriate interventions.

This application claims priority to U.S. Provisional Application 60/565,769 filed Apr. 27, 2004, and herein incorporated by reference in its entirety.

This work was supported, in part, by grant RO1 DC00646 from the Public Health Service and K23 DK62170-01. The government may have certain rights in the invention.

### FIELD OF THE INVENTION

The present invention relates to devices and methods for imaging, characterizing, diagnosing, and treating junctions between internal body areas and for analyzing, measuring, and monitoring pressure/volume relationships of body areas. In particular, the devices and methods of the present invention find use in distinguishing normal, non-hernia, reflux, and hernia patients for diagnostic purposes, drug screening, and selecting and monitoring appropriate interventions.

### BACKGROUND

The primary determinant of gastroesophageal reflux is esophogastric junction (EGJ) incompetence permitting excessive reflux of gastric juice into the esophagus. Reflux events may occur in the context of transient lower esophageal sphincter relaxations (tLESRs), strain induced reflux, or free reflux during periods of either low LES pressure or deglutitive relaxation (see, e.g., Dent J, et al., 1980, J Clin Invest 65:256-67; Dodds W J, et al., 1982, N Engl J Med 307:1547-52; Barham C P, et al., 1995, Gut 36:505-10; Mittal R K, et al., 1995, Gastroenterology 109:601-10; each herein incorporated by reference in their entireties). tLESRs account for up to 90% of reflux episodes in asymptomatic controls and in symptomatic GERD patients without hiatus hernia (HH) (see, e.g., Dent J, et al., 1980, J Clin Invest 65:256-67; van Herwaarden M A, et al., 2000, Gastroenterology 119:1439-46; Schoeman M N, et al., 1995 Gastroenterology 108:83-91; each herein incorporated by reference in their entireties). In contrast, GERD patients with HH exhibit a more heterogeneous reflux pattern with reflux episodes frequently occurring during periods of low LES pressure, straining, and even swallow-induced LES relaxation (see, e.g., van Herwaarden M A, et al., 2000, Gastroenterology 119:1439-46; Barham C P, et al., 1995, Gut 36:505-10; each herein incorporated by reference in their entireties). The EGJ opens at lower pressures and to a greater diameter during LES relaxation in HH patients compared to asymptomatic normal subjects (see, e.g., Pandolfino J E, et al., 2002, Am J Physiol Gastrointest Liver Physiol 282:G1052-8; herein incorporated by reference in its entirety). A qualitative difference exists in the air/liquid content of refluxate between normal subjects and GERD patients (see, e.g., Sifrim D, et al., 1996 Gastroenterology 110:659-68; Sifrim D, et al., 1999 Gut 44:47-54; each herein incorporated by reference in their entireties). Although tLESRs are a dominant mechanism of reflux in normal controls and in reflux patients when evaluated as a heterogeneous group, unique mechanistic considerations amongst GERD patients exist with HH (see, e.g., Mittal R K, et al., 1995 Gastroenterology 109:601-10; van Herwaarden M A, et al., 2000 Gastroenterology 2000;1 19:1439-46; Kahrilas P J, et al., 2000 Gastroenterology 2000;118:688-95; Sloan S, et al., 1991 Gastroenterology 100:596-605; Jones M P, et al., 2002 Neurogastroenterol Motil 14;625-63 1; each herein incorporated by reference in their entireties). Factors that may contribute to increased compliance of the EGJ include radial disruption of the crural diaphragm, integrity of the phrenoesophageal ligament, grade of gastroesophageal flap valve or thickness of the LES smooth muscle (see, e.g., Hill L D, et al., 1996 Gastrointest Endosc 44:541-7; Pehlivanov N, et al, 2001 Am J Physiol Gastrointest Liver Physiol 280:G1093-8; each herein incorporated by reference in their entireties).

What is needed are improved devices and methods for imaging the EGJ, and improved methods of diagnosing and treating GERD and related conditions.

### SUMMARY

The present invention relates to systems, devices, and methods for imaging, characterizing, diagnosing, monitoring changes in, and treating junctions between internal body areas. In particular, the systems, devices and methods of the present invention find use in distinguishing normal, non-hernia, reflux, and hernia patients for diagnostic purposes, drug screening, selecting and monitoring appropriate interventions. The systems, devices, and methods of the present invention also find use in many other applications. A number of exemplary applications are illustrated herein. One skilled in the art will appreciate additional applications of the systems, devices, and methods of the present invention.

In certain embodiments, the present invention provides a device for imaging a junction between internal body areas comprising a bag configured to receive an imaging agent such that the size of the bag is proportional to the amount of the imaging agent received by the bag, wherein the bag is configured to engage the junction such that the imaging agent permits imaging of the junction. In certain preferred embodiments, the imaging permits the calculation of the cross sectional area of the junction. In certain preferred embodiments, the imaging permits the calculation of the cross sectional area of the junction at specific degrees of inflation of the bag. In other preferred embodiments, the imaging permits the measurement of liquid passing through the junction and the pressure exerted by the EGJ on the bag. In certain preferred embodiments, the results of a therapeutic intervention can be assessed by measuring the change in the pressure exerted on the bag by the EGJ during and after a therapeutic intervention.

In preferred embodiments, the junction is an esophogastric junction. In other preferred embodiments, the junction comprises a sphincter muscle.

In preferred embodiments, the composition of the bag is polyethylene. In other preferred embodiments, the imaging agent is provided to the bag through a barostat assembly. In yet other preferred embodiments, the barostat assembly provides the imaging agent to the bag under a predetermined pressure such that the bag assumes the pressure. In preferred embodiments, when filled with a specific amount of fluid, the bag is configured to exert a distension pressure upon the junction. In most preferred embodiments, a cold liquid is used to fill the bag and cool the lining of the junction during the application of thermal energy thereto.

In preferred embodiments, the device further comprises a manometric catheter, and the pressure of the liquid within the bag is measured with the manometric catheter.

In preferred embodiments, the device is used to diagnose an illness (e.g., GERD). In other preferred embodiments, the device is used to image the effect of a drug. In yet other preferred embodiments, the device further comprises an endoscopic tube. In yet other preferred embodiments, the device is configured to analyze and/or perform endoscopic lithotripsy. In preferred embodiments, the device is configured to apply thermal energy to shrink the junction therapeutically.

In certain embodiments, the present invention provides a system for imaging a junction between body areas comprising, a barostat component comprising a radioopaque imaging agent; a bag component connectable to the barostat via tubing, the bag component configured to receive the imaging agent through the tubing, the bag further configured to engage the junction; and an imaging component configured to measure cross-sectional area of the junction as a function of pressure within the bag. In preferred embodiments, the barostat component provides the imaging agent to the bag component under a predetermined pressure such that the bag assumes the pressure. In preferred embodiments, the bag component is made of polyethylene.

In preferred embodiments, the system further comprises a manometric catheter configured to measure pressure within the bag component. In preferred embodiments, the system further compres an endoscopic tube. In preferred embodiments, the system further comprises a thermal energy component selected from the group consisting of a laser energy component, a radiofrequency energy component, a microwave energy component, and an ultrasound energy component. In other preferred embodiments, the thermal energy component is configured to delivery thermal energy in a manner perpendicular to the axis of the bag.

In certain embodiments, the system is used within a method of analyzing a body area of a subject, wherein the system is provided, and the body area is contacted with the bag component. In preferred embodiments, the body area comprises an esophogastric junction. In preferred embodiments, the body area comprises a sphincter muscle. In preferred embodiments, the method further comprises the step of measuring a cross-sectional area of the junction as a function of pressure within the bag. In preferred embodiments, the method further comprises the step of diagnosing a disease or condition based on data obtained from the system. In yet other preferred embodiments, the disease or condition is GERD. In yet other preferred embodiments, the disease or condition is GERD with hiatus hernia. In still other preferred embodiments, the disease or condition is GERD without hiatus hernia. In preferred embodiments, the disease or condition is female stress urinary incontinence. In preferred embodiments, the disease or condition is fecal incontinence.

In preferred embodiments, the method further comprises the step of monitoring a medical procedure by monitoring the imaging component. In preferred embodiments, the medical procedure comprises a surgery. In still other preferred embodiments, the surgery comprises endoscopic lithotripsy. In preferred embodiments, the medical procedure comprises a drug therapy. In yet other preferred embodiments, the drug therapy comprises application of a drug selected from the group consisting of an anti-cancer agent, ranitidine, cimetidine, famotidine, nizatidine, omeprazole, lansoprozole, rabeprazole, esomeprazole, and metoclopramide. In preferred embodiments, the medical procedure comprises application of a thermal energy selected from the group consisting of laser energy, radiofrequency energy, microwave energy, and ultrasound energy.

In certain embodiments, the present invention provides a system for imaging a body area comprising, a barostat component comprising a radioopaque imaging agent; a bag component connectable to the barostat via tubing, the bag component configured to receive the imaging agent through the tubing, the bag further configured to engage the junction; an imaging component configured to analyze the body area as function of pressure within the bag; and a therapeutic component.

In preferred embodiments, the therapeutic component is a therapeutic drug. In preferred embodiments, the therapeutic component provides a cooling component to reduce the temperature of the imaging agent. In preferred embodiments, the therapeutic component is selected from the group consisting of laser energy, radiofrequency energy, microwave energy, and ultrasound energy.

In preferred embodiments, the system is configured for fiber-optic delivery of the laser energy. In other preferred embodiments, the laser energy is delivered at a range of about 70 to 110 degrees from the axis of the fiber-optic. In preferred embodiments, the therapeutic drug is selected from the group consisting of an anti-cancer agent, ranitidine, cimetidine, famotidine, nizatidine, omeprazole, lansoprozole, rabeprazole, esomeprazole, and metoclopramide.

In certain embodiments, the system is used within a method of treating a subject comprising treating the subject with a thermal energy emitting component; and monitoring the treating by detecting the imaging component. In preferred embodiments, the subject suffers from or is suspected of suffering from a condition selected from the group consisting of GERD, female stress urinary incontinence, fecal incontinence, and cancer.

### DESCRIPTION OF THE FIGURES

FIG. 1 displays a schematic diagram of an imaging system/device in one embodiment of the present invention.

FIG. 2 depicts a combination imaging, barostatic measuring, and therapeutic system. In particular, the system comprises an imaging device containing a conduit disposed within a catheter. As shown, a quartz or fused silica capillary tube creates an air interface at the beveled distal end face of the conduit. An air interface may be used for total internal reflection of light energy, which is shown to exit capillary tube laterally at an angle of about 70 degrees to about 110 degrees from the axis of conduit, through the light exit port in catheter, as shown by arrows. A bag is disposed over the distal end portion of catheter. Fluid flows out of the bag through a port into a channel of the catheter.

FIG. 3 depicts a preferred embodiment of an imaging device of the present invention. The imaging bag expands within a 500 cc glass container filled with 50% renograffin. Pressure applied by the barostat bag is transmitted to the contrast filled bag straddling the EGJ through a noncompliant polyvinyl tube. A solid-state manometry catheter is also placed into the end of the hydrostat bag to monitor pressure and ensure correlation between the barostat setting and the pressure within the contrast filled bag.

FIG. 4 depicts representative images of three study groups taken with an imaging device of the present invention.

FIG. 5 depicts the dimensions and radial symmetry of the EGJ.

FIG. 6 depicts the EGJ cross sectional area as a function of distention pressure.

### DETAILED DESCRIPTION

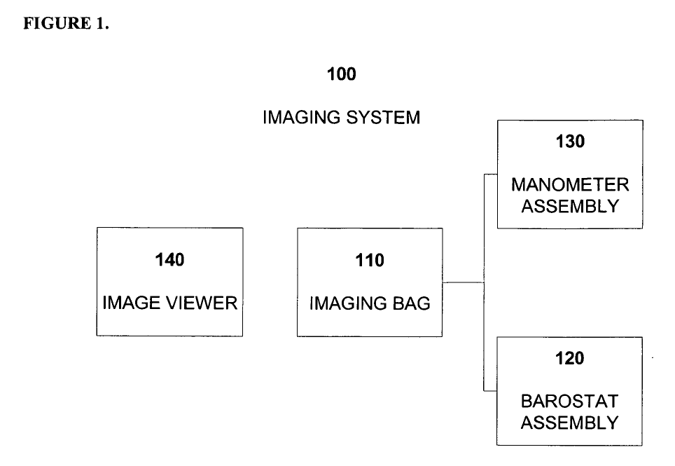

The present invention provides imaging devices for imaging body areas, methods for measuring the dimensions of body areas (e.g., cross sectional area), and monitoring of therapeutic applications thereof. The devices and systems of the present invention also find use in any application where pressure/volume relationships of body areas are to be measured, monitored, or analyzed. In preferred embodiments, the imaging devices are used in the imaging of junctions between internal body areas (e.g., EGJ, pyloric junction sphincter, duodenum junction, jejunum junction, ileum junction, colon opening, rectal opening, oral opening, ureter pelvic junction, trachea /lung junction, gall bladder openings, ureter bladder opening, or any opening or junction between internal body areas). The system, devices, and methods also find use in any situation where a pressure/volume relationship is relevant, including, but not limited to removal of skin flaps, wound closings, breast or other augmentation or implant processes, etc. The illustrated and preferred embodiments discuss these devices, methods and applications in the context of imaging the EGJ and methods of diagnosing gastric related illnesses (e.g., GERD). FIGS. 1-6 illustrate various preferred embodiments of the devices of the present invention. The present invention is not limited to these particular embodiments.

In preferred embodiments, the devices of the present invention find use within medical functions as a means for imaging and diagnosing illnesses, conditions, and tissue properties involving a junction between internal body areas (e.g., GERD). The imaging devices of the present invention provide numerous advantages over prior art imaging techniques including, but not limited to, improved imaging of junctions between internal body areas, improved ability to diagnose junction related illnesses, improved ability to profile the mechanical characteristics of a junction, improved ability to calculate the cross sectional area of a junction, improved ability to visualize junctions, and improved ability to monitor therapeutic applications thereof.

The imaging devices of the present invention function under the principle that the profiling of a junction between internal body areas in response to varied distension pressures permits a mechanical characterization of the junction. The diagnostic devices of the present invention enable compliance and opening pressures of the junction to be measured, thereby permitting assessment of the therapeutic. Characterization of a junction between internal body areas permits improved diagnoses, therapy monitoring, and treatment options for junction related disorders.

Imaging Devices

FIG. 1 displays a schematic diagram of an imaging device 100 in a preferred embodiment. The imaging device 100 generally comprises an imaging bag 110, a barostat assembly 120, a manometer assembly 130, and an image viewer 140. The imaging device 100 is not limited to particular size. In preferred embodiments, the imaging device 100 is configured to image an internal body (e.g., mammal, human, dog, ape) opening (e.g., esophograstric or other junction) (described in more detail below).

Still referring to FIG. 1, the imaging bag 110 is configured for inflation and deflation. In preferred embodiments, the imaging bag 110 is configured to apply distension pressures upon an internal body area. The imaging bag 110 is not limited to a particular composition (e.g., nylon, plastic, polyethylene, rubber, or mixtures thereof). In preferred embodiments, the composition of the imaging bag 110 is polyethylene. The imaging bag 110 is not limited to a particular shape (e.g., crumpled, oval, cylindrical). The imaging bag 110 is not limited to a particular appearance (e.g., opaque, transparent). In preferred embodiments, the imaging bag 110 is transparent. In preferred embodiments, the inflated shape of the imaging bag 110 is cylindrical. The imaging bag 110 is not limited to a particular size upon full inflation. In preferred embodiments, the size of the imaging bag 110 upon full inflation is 2 cm in diameter and 10 cm in length. In preferred embodiments, the deflated shape of the imaging bag 110 is folded. In preferred embodiments, the imaging bag 110 assumes an inflated cylindrical shape upon receipt of an imaging agent (e.g., renograffin, radio-opaque imaging agent). In some embodiments, the imaging bag 110 has impedance wires for calculating the diameter of the imaging bag 110. In preferred embodiments, the imaging bag 110 is configured for engagement with an internal body area (e.g., EGJ, pyloric junction sphincter, duodenum junction, jejunum junction, ileum junction, colon opening, rectal opening, oral opening, ureter pelvic junction, trachea /lung junction, gall bladder openings, ureter bladder opening, or any opening or junction between internal body areas) such that the internal body area may be imaged and monitored during therapy (described in more detail below). The thickness of the imaging bag 110 can vary according to the selected type fluid and the type of energy (e.g., laser energy, radiofrequency energy, microwave energy, ultrasound energy; described in more detail below) to be utilized. The thickness and tensile strength of the imaging bag 110 is such that it can withstand the inflated pressure of the fluid when fully inflated. This pressure is typically about 2 to 4 atmospheres of pressure, although the pressure level can be greater or lesser.

Still referring to FIG. 1, in preferred embodiments, the barostat assembly 120 serves to provide the imaging bag 110 with an imaging agent (e.g., renograffin, radio-opaque imaging agent). The barostat assembly 120 is not limited to a particular method of providing imaging agent to the imaging bag 110. In some preferred embodiments, the barostat assembly 120 generally comprises a barostat, first and second tubes, a barostat bag, a container, and an imaging agent. The present invention is not limited to a particular type of barostat. In preferred embodiments, the barostat is an electronic barostat (e.g., Distender Series II, Dual Drive Barostat, G and J Electronics). The present invention is not limited to particular types of first and second tubes. In preferred embodiments, the first and second tubes are large bore polyvinyl tubes (e.g., OD 4.0 mm; ID, 3.2 mm). The barostat bag is not limited to a particular composition (e.g., nylon, plastic, polyethylene, rubber, or mixtures thereof). In preferred embodiments, the barostat bag is made of polyethylene or other material transmissive to the type of thermal energy employed for therapeutic purposes. The present invention is not limited to a particular type of imaging agent (e.g., barium sulfate, gastrograffin, technetium, iodine, renograffin, indium, fluorine, radio-opaque imaging agents). Radio-opaque imaging agents are described, for example, in U.S. Pat. No. 6,751,290, herein incorporated by reference in its entirety. In preferred embodiments, the imaging agent is a liquid-based imaging agent. The imaging agent can be cooled to reduce the temperature of the lining of the junction. In preferred embodiments, the imaging agent is renograffin. The present invention is not limited to a particular type of container. In preferred embodiments, the container is a 500 cc glass container with a two-holed rubber stopper lid.

Still referring to FIG. 1, in preferred embodiments, the barostat bag is positioned within the container, and is connected to the barostat via a first tube through the two-holed rubber stopper lid. In preferred embodiments, approximately 50% of the container is filled with the imaging agent. In preferred embodiments, a second tube connects the container to the imaging bag 110 through the second hole of the two-holed rubber stopper lid. In preferred embodiments, the air within the container is in a vacuum (e.g., partial vacuum). In preferred embodiments, the barostat assembly 120 provides the imaging bag 110 with an imaging agent under pressure (e.g., −4 mmHg, −2 mmHg, 0 mmHg, 2 mmHg, 4 mmHg, 6 mmHg, etc). The barostat assembly 120 is configured such that the barostat delivers pressurized air through the first tube to the barostat bag so as to inflate the barostat bag. Inflation of the barostat bag reduces the overall air volume of the container. Reduction of the overall air volume of the container causes the imaging agent to be pumped from the container to the imaging bag 110 via the second tube in a manner consistent with the pressure setting of the barostat.

Still referring to FIG. 1, the manometer assembly 130 serves to measure the pressure within the imaging bag 110. The manometer assembly 130 generally comprises a manometric catheter, a manometer, and a pressure reader. The present invention is not limited to a particular manometric catheter. In preferred embodiments, the manometric catheter is an 8-lumen silicone rubber extension with a 6 cm sleeve sensor with seven side hole recording sites. In preferred embodiments, the seven side hole recording sites are connected to extracorporeal pressure transducers. In preferred embodiments, the manometric catheter is configured for perfusion with a liquid (e.g., sterile water). The present invention is not limited to a particular manometer. In preferred embodiments, the manometer is a solid state manometer. In preferred embodiments, the manometer is configured to take timed pressure readings (e.g., in hundredths of a second). The present invention is not limited to a particular pressure reader. In preferred embodiments, the pressure reader is a computer (e.g., a computer polygraph). In preferred embodiments, the manometric catheter is connected with the imaging bag 110 and the manometer such that the seven side hole recording sites of the manometric catheter are positioned inside of the imaging bag 110. In preferred embodiments, the pressure reader is connected to the manometer.

Still referring to FIG. 1, the image viewer 140 serves to provide images from the imaging device 100. The present invention is not limited to a particular type of image viewer 140. In preferred embodiments, the image viewer 140 is a fluoroscope. In preferred embodiments, the image viewer 140 utilizes imaging software (e.g., National Institutes of Health imaging software). In preferred embodiments, the imaging software permits the display of images synchronous with the manometer assembly 130 readings and the hydrostat assembly 120 readings. In preferred embodiments, the imaging software permits the display of images in real time. In preferred embodiments, the imaging software permits “point and click” displaying of images from desired locations or positions of the system or tissue.

Still referring to FIG. 1, the imaging device 100 is not limited to particular method of entry into a body (e.g., anally, orally, vaginally, urethrally, intranasally, oticly, surgically). In preferred embodiments, the imaging device 100 is configured for oral entry into a body. In such embodiments, a subject orally passes the imaging bag 110 connected with the barostat assembly 130 and hydrostat assembly 120. In preferred embodiments, the imaging bag 110 is positioned in its desired location (e.g., esophogastreal junction) through use of the image viewer 140 (e.g., fluoroscope).

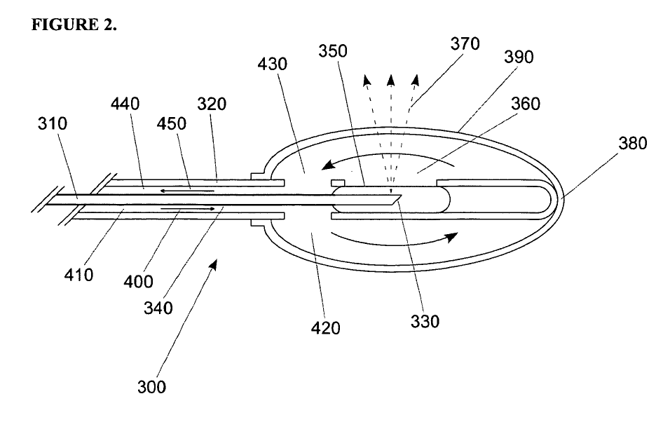

FIG. 2 depicts an alternate image device 300 embodiment that also provides a means for therapeutic intervention. As shown, FIG. 2 presents a combination imaging, barostatic measuring, and therapeutic system. The imaging device 300 contains conduit 310, which in this embodiment is a quartz or fused silica optical fiber which is disposed within catheter 320. The distal end face 330 of conduit 310 is beveled at an angle (e.g., between approximately 37 to 45 degrees) from the axis of conduit 310. Buffer coat and vinyl cladding 340 have been removed from the distal end portion of conduit 310. A quartz or fused silica capillary tube 350, whose distal end has been closed by fusing, and whose proximal end is attached to the bared portion of conduit 310 by thermal fusing or an adhesive, creates an air interface at the beveled distal end face 330 of conduit 310. An air interface may be used for total internal reflection of light energy, which is seen to exit capillary tube 350 laterally at an angle of about 70 degrees to about 110 degrees from the axis of conduit 310, through light exit port 360 in catheter 320, as shown by arrows 370. In this embodiment, catheter 320 is preferably a metal or plastic tube or needle, preferably of stainless steel, whose distal end 380 has been closed and rounded into an atraumatic shape. A bag 390 is disposed over the distal end portion of catheter 320. Arrow 400 indicates the direction of fluid inflow through channel 410 and port 420 of catheter 320 into bag 390. Fluid flows out of bag 390 through port 430 into channel 440 of catheter 320, in the direction of flow indicated by arrow 450. In preferred embodiments, the beveled optical fiber/capillary tube assembly, with radio-opaque markers, is configured to be moveably disposed within the bag. In preferred embodiments, the fluid in the bag 390 is in communication with an external barostat. In preferred embodiments, the fluid is radio-opaque for imaging by x-ray.

Uses of the Imaging Devices

The imaging devices of the present invention are not limited to particular uses (e.g., profiling internal body areas, diagnostic applications, therapeutic applications). In preferred embodiments, the imaging devices are useful in general imaging and analysis of a body area.

In preferred embodiments, the imaging devices of the present invention are used in profiling the opening characteristics (e.g., pressure/volume) of an internal body area (e.g., EGJ, pyloric junction sphincter, duodenum junction, jejunum junction, ileum junction, colon opening, rectal opening, oral opening, ureter pelvic junction, trachea/lung junction, gall bladder openings, ureter bladder opening, or any opening or junction between two internal body areas). For example, measurements (e.g., cross sectional area) of an internal body area may be made as a function of various distension pressures from the imaging bag so as to generate an operating profile of the internal body area.

In preferred embodiments, the imaging devices of the present invention are useful in visualizing internal body areas and making diagnoses (e.g., diagnosing GERD, esophogastric cancer, detecting tumor formation, cancer, colon cancer, diagnosing female urinary stress incontinence, fecal (anal) incontinence, etc.).

In preferred embodiments, the imaging devices are useful in therapeutic applications. In preferred embodiments, the imaging devices of the present invention are used in conjunction with an endoscope or enteroscope for treatment purposes (e.g., esophagogastroduodenoscopy, endoscopic lithotripsy, colonoscopy, drug delivery, tumor removal). For example, in some embodiments, the imaging devices may be used to deliver drugs useful in treating GERD (e.g., H2 receptor antagonists, ranitidine, cimetidine, famotidine, nizatidine, proton pump inhibitors, omeprazole, lansoprozole, rabeprazole, esomeprazole, prokinetics, metoclopramide, etc.) or cancer (e.g., anti-cancer drugs).

In preferred embodiments, the system includes a laser (e.g., side firing laser, lateral firing laser) or other heating component (e.g., a heating component emitting radiofrequency, microwave energy, or ultrasound energy) configured for treating tissue (e.g., to cause scar formation or collagen contraction). A preferred method of using a lateral-firing laser device is described in more detail in U.S. Pat. No. 5,437,660, herein incorporated by reference in its entirety.

Laser and radiofrequency energy is commonly used, for example, in the treatment of herniated or ruptured spinal discs so as to relieve pressure against nerves, and to shrink shoulder capsule so as to prevent shoulder dislocation. In cosmetic and dermatologic procedures, laser energy is applied to the skin to cause shrinkage and growth of the new collagen in tissues lying beneath the epidermis to treat wrinkles or to coagulate unattractive blood vessels beneath the skin. To prevent thermal damage to the epidermis, a coolant, such as a cryogenic gas, ambient air, a fluid spray, a refrigerated, transparent gel or a cooled fluid circulated through a container with quartz or fused silica windows, can be applied to the surface of the skin to cool the epidermis. Laser energy can safely be transmitted through aqueous liquids. The laser may be provided as part of an endoscope, hydrostat, or with any other part of the system or may be provided as a separate component. In preferred embodiments, imaging systems are provided such that energy (e.g., laser energy) transmitted along a catheter may be directed at tissue through an energy emitter (e.g., fiber optic laser delivery component) that is substantially surrounded by an imaging big filled with a fluid coolant (e.g., chilled de-ionized water, chilled saline, and cryogenic-state gas). In preferred embodiments, a cold liquid medium is preferred, as that the liquid medium serves as a cooling agent during application of laser or other thermal energy to the junction.

The imaging system, when used with the laser or other heating component, permits real-time monitoring of therapy to assist in achieving the best outcome. In preferred embodiments, the imaging system is configured such that the pressure exerted by an opening (e.g., EGJ) may be monitored before and after the administration of a therapy (e.g., laser energy). As such, the imaging system permits a user to, for example, apply a therapy (e.g., laser energy), monitor the effect of the therapy by measuring the pressure exerted by the opening, and reapply the therapy until a desired opening pressure is reached.

Utilization of laser or other thermal energy within a cold liquid medium contained in a bag or balloon inflated within the junction assists in preventing thermal injury to the endothelial lining of the EGJ or other junction, while permitting the laser energy to pass through the endothelial lining to shrink the collagen in the underlying tissues by photomechanical cross linking (see, e.g., U.S. patent application Ser. Nos. 20030060813 and 20040120668; each herein incorporated by reference in their entireties). The devices and systems of the present invention may be integrated with one or more portions of the devices and systems described in U.S. patent application Ser. Nos. 20030060813 and 20040120668 to provide enhanced systems for modifying tissues surrounding a duct, hollow organ or body cavity.

In preferred embodiments, the imaging devices are useful in assisting in wound closing (e.g., removing skin flaps through stretching). In preferred embodiments, the imaging devices are useful in prosthetic surgery (e.g., breast augmentation).

In preferred embodiments, the imaging devices are useful in the screening and monitoring of drugs. For example, the effect of a drug on a certain internal body position (e.g., the EGJ) may be monitored and imaged with the imaging devices.

In preferred embodiments, the imaging devices of the present invention are useful in generating a profile of the esophogastric junction (EGJ) leading to a diagnosis of gastroesophageal reflux disease (GERD). For example, liquid flow through and into (e.g., reflux) the EGJ may be measured as varying amounts of distention pressure is applied from the imaging bag. Such a profile permits an understanding of the mechanical properties of the EGJ and permits distinction between various illnesses (e.g., distinguishing between GERD patients with and without hiatus hernia). In preferred embodiments, the imaging devices assist, for example, in explaining the distinct reflux profile observed in HH patients (e.g., a mechanistic difference in EGJ opening characteristics rather than of LES relaxation per se). In preferred embodiments, the imaging devices are used in exploring the mechanical properties of the relaxed EGJ in an opening diameter range (>10 mm) and a distensive pressure range (10-30 mmHg) greater than believed to be physiologically important in GERD.

In preferred embodiments, the imaging devices are used in exploring the mechanical characteristics of EGJ opening in GERD patients and normal subjects at physiological apertures and intraluminal pressures. In preferred embodiments, the monitoring of a treatment enables a user (e.g., physician) to assess changes in and the status of the EGJ or other junction after a therapeutic application (e.g., application of a particular drug dosage, sufficiency of a laser energy, radiofrequency (RF), microwave or ultrasound energy application, or the sufficiency of any other therapeutic application).

### EXPERIMENTAL

The following examples are provided to demonstrate and further illustrate certain preferred embodiments of the present invention and are not to be construed as limiting the scope thereof.

### Example I

Seven normal subjects (NL) (4 males, 23-33 years old) without reflux symptoms, 7 patients with GERD and HH (HH) (5 males, 28-53 years old) and 9 GERD patients without HH (NHH) (5 males, 24-48 years old) were studied. Patients were classified as HH or NHH based on upper endoscopy results. The endoscopic criterion for HH was that the position of the SCJ was ≧2 cm proximal to the center of the hiatal impression after aspirating excess air from the stomach. Presence or absence of HH was confirmed with fluoroscopy using the criterion of persistent rugal folds proximal to the hiatus between dilute barium swallows. The HH subjects had axial displacement ranging from 2.0 cm to 4.4 cm based on fluoroscopic measurements. Non hiatus hernia patients had <1 cm axial herniation during endoscopy and subsequent fluoroscopy. As shown in Table 1, GERD was defined by the presence of ≧Los Angeles A esophagitis on current or recent endoscopy (HH, 5/7; NHH 2/9) and/or abnormal 24 hour ambulatory pH monitoring using a cutoff value of 4.2% total time pH <4 (HH, 2/7, NHH, 9/9). At the time of the experimental study, all patients were in symptomatic remission as a result of maintenance treatment with a proton pump inhibitor (n=12) or nonprescription therapy (n=4) and none were taking any medication known to affect esophageal contractility. None of the subjects had a history of surgical manipulation of the EGJ. Table 1. Study subject demographics.

TABLE 1

| | Normal | GERD without | GERD with |
|---|---|---|---|
| | Subjects | Hiatus Hernia | Hiatus Hernia |
| Male/total subjects | 4/7 | 5/9 | 5/7 |
| Age range (yrs) | 23-32 | 24-48 | 28-53 |
| Esophagitis | 0/7 | 2/9 | 5/7 |
| Abnormal pH study* | 0/7 | 9/9 | 7/7 |

*Total % time pH < 4 greater than 4.2%

### Example II

This Example describes the manometric procedures used in experiments conducted in some embodiments the present invention. Subjects underwent baseline manometry before or shortly after the hydrostat protocol, but never on the same day. Manometry was done using a water-perfused system (Dentsleeve Pty. Ltd, Parkside, South Australia). The manometric catheter was an 8-lumen silicone rubber extrusion with a 6 cm sleeve sensor and 7 side-hole recording sites. Each side-hole channel was connected to an extracorporeal pressure transducer and perfused with sterile water at 0.15 ml/min using a low compliance perfusion pump (Dentsleeve Mark II, 16 channel model); the sleeve channel was perfused at 0.6 ml/min. Output of the pressure transducers was connected to a computer polygraph set at a sampling frequency of 40Hz (Neomedix systems Pty Ltd, Warriedwood, NSW, Australia) and processed using Gastromac software (Neomedix systems Pty Ltd, Warriedwood, NSW, Australia). The transducers were calibrated at 0 and 70 mmHg prior to recording using externally applied pressure. Response characteristics of each side-hole manometric channel exceeded 200 mmHg/s. Basal LES pressure was measured at end expiration during a 5-minute baseline period. Relaxation pressure was defined as the mean LES pressure during maximal deglutitive relaxation. All manometric pressure values were referenced to intragastric pressure.

### Example III

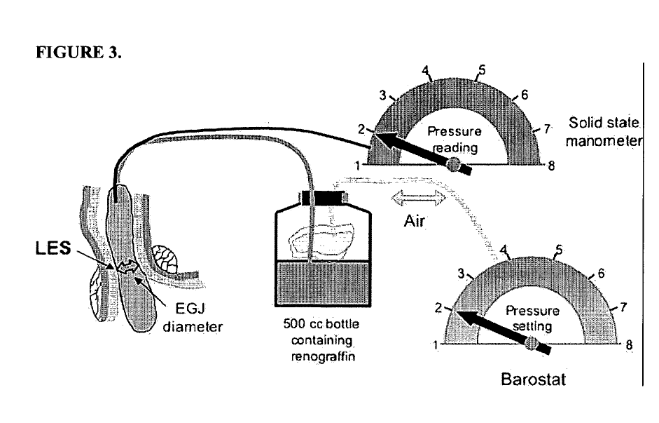

This Example describes the hydrostatic instrumentation used in some embodiments of the present invention. FIG. 3 depicts a preferred embodiment of an imaging device of the present invention. The imaging bag expands within a 500 cc glass container filled with 50% renograffin. Pressure applied by the barostat bag is transmitted to the contrast filled bag straddling the EGJ through a noncompliant polyvinyl tube. A solid-state manometry catheter is also placed into the end of the hydrostat bag to monitor pressure and ensure correlation between the barostat setting and the pressure within the contrast filled bag. As shown in FIG. 3, the hydrostat was designed as a means of improving fluoroscopic imaging of the EGJ at minimal opening diameters. An electronic barostat (Distender Series II, Dual Drive Barostat, G and J Electronics) was connected to a large bore polyvinyl tube (OD 4.0 mm; ID, 3.2 mm) that was in turn connected to a 250 cc bag. The barostat bag was made from polyethylene sandwich bags using a heating iron (Impulse Heat Sealer, Midwest Pacific, St. Louis, Mo.) and tied to the end of the tubing with nylon suture. The unique adaptation of the hydrostat was to place the barostat bag within a 500 cc glass container via a two-holed rubber stopper. The glass container was partially filled with 50% renograffin. Barostat bag expansion then resulted in renograffin flow through a second piece of polyvinyl tubing traversing the second hole in the rubber stopper and connected to a second bag (hydrostat) that then filled with renograffin to the pressure setting of the barostat.

Hydrostat bags were designed so that when fully distended they had a cylindrical shape, 2 cm in diameter and 10 cm in length. The length of the bag ensured that position could be maintained across the EGJ during distention without need for repositioning. Hydrostat bags were end-mounted on the polyvinyl tubing with nylon surgical suture over a plastic tie point. In addition, a single sensor solid-state manometric catheter (Medical Measurements Inc., Hackensack, N.J.) was incorporated into the assembly positioned such that the sensor was within the hydrostat bag, 1 cm beyond the distal end of the polyvinyl tubing. Prior to use, the entire system was checked for leaks ex-vivo by inflation to 40 mmHg.

### Example IV

This Example describes an experimental protocol used in some embodiments of the present invention. After an overnight fast, the hydrostat catheter was passed orally with the patient in a sitting position such that the end of the catheter was at least 50 cm distal to the incisors. The subject was then placed in a supine position under a fluoroscope (Easy Diagnostics, Phillips Medical Systems, Shelton, Conn., USA) and shielded below the umbilicus with a lead apron. The assembly was positioned under fluoroscopy such that the bag was within the stomach. Pressure within the hydrostat bag was heavily dependent on hydrostatic considerations. Prior to experimentation the height of the hydrostat bottle was adjusted in relation to the patient such that there was no flow of contrast within the system. Intragastric pressure was then measured for a one-minute period. Guided by fluoroscopy, the bag was then unfolded, positioned straddling the EGJ, and secured in position to the subject's cheek with tape.

### Example V

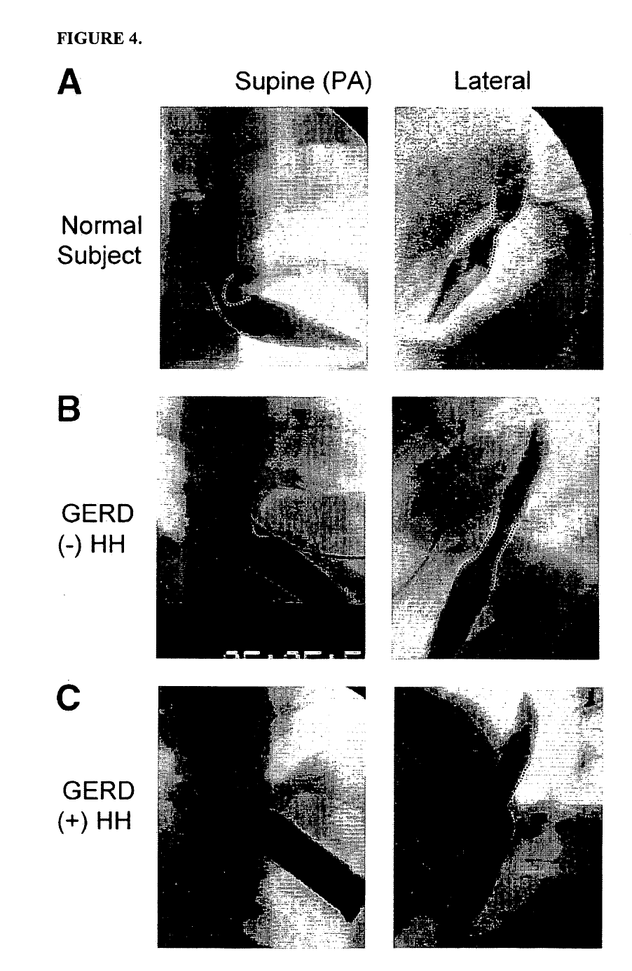

This Example describes the EGJ anatomy and distensibility (e.g., compliance) observed via use of the systems of the present invention. EGJ opening dimensions were imaged in both posterior-anterior (PA) and lateral projections during deglutitive relaxation as a function of hydrostat distension pressure. Distention pressure was increased in 2 mmHg increments up to 12 mmHg (see FIG. 4). One swallow was recorded at each pressure with the potential for a repeat swallow if the first was technically inadequate. Fluoroscopic images were recorded using a videotape recorder (Panasonic VO 9800) and synchronized with manometric data from the single solid state catheter in the proximal portion of the hydrostat bag and the pressure volume data from the barostat using a video timer (model VC 436, Thalner Electronics Laboratories, Ann Arbor, Mich., USA) that encoded time in hundredths of a second on each video frame and sent a 1V-10 ms pulse to an instrumentation channel of the polygraph at whole second intervals.

### Example VI

This Example describes the mechanical simulation of air and water flow through the EGJ in some embodiments of the present invention. In order to estimate the impact of observed EGJ opening apertures on flow of air and water across the EGJ the barostat and hydrostat was set up to measure flow through 1 cm lengths of polyurethane tubing. Tubing sizes were selected so as to encompass the average opening apertures of the three subject groups observed during 4mmHg distension (the average pressure increment observed during tLESRs). The barostat was used to measured air flow rates and the hydrostat was used to measure water flow rates. Air and water flow rates through the simulation tubing were measured for 20 seconds and mean flow rate reported. The maximal barostat inflation rate was measured to be 57 ml/sec without any outflow restriction. Therefore, flow rates were extrapolated using a liquid:air viscosity ratio of 55:1 when maximal flow rate was exceeded.

### Example VII

This Example describes the data analysis used in experiments conducted in some embodiments of the present invention. Maximal deglutitive opening diameter at the narrowest point within the EGJ was measured from digitized videofluorographic images using Macintosh video and NIH image software. A vertebra was used as a spatial reference and the 10 mm length of the proximal tie ring on the hydrostat assembly was used to correct for magnification (see FIG. 4). Hydrostat distention pressures were indexed to intragastric pressure. Cross sectional surface area at the narrowest part of the EGJ was calculated using the formula for the area of an ellipse using the P-A and lateral radii (Area=R_{A-P}•R_{L}•π).

All results are summarized as mean ±SEM unless specified otherwise. One-way ANOVA was used to compare the manometric parameters among the three groups. Student's paired t-test was used to compare the manometric parameters between groups with p<0.0253 considered significant. ANOVA was used to compare differences in EGJ opening cross sectional area among subject groups at each distensive pressure. Slope of the area pressure relationship was calculated using simple regression analysis. Least square regression analysis was used to determine the correlation between the slope of the area/pressure relationship and the basal LES pressure. A p value <0.05 was considered significant.

### Example VIII

This Example describes the manometric measures of EGJ function as measured in some embodiments of the present invention. Manometric data for each group are shown in Table 2. Using ANOVA, no significant difference existed in mean basal LES pressure among the three groups. An unpaired t-test revealed a significant difference in LES pressure between NL and HH patients (p<0.005). Neither ANOVA nor an unpaired t-test revealed any significant differences in LES relaxation pressure or intragastric pressure among the three subject groups.

TABLE 2
Manometric measures of EGJ function among subject groups.

| | Normal | GERD without | GERD with |
|---|---|---|---|
| | Subjects | hiatus hernia | hiatus hernia |
| Basal LES | 15.6 ± 1.1 | 12.2 ± 2.0 mmHg | 9.7 ± 1.2 mmHg* |
| Pressure | mmHg | | |
| (mean ± SE) | | | |
| LES Relaxation | 1.6 ± 1.4 | 1.5 ± 1.8 mmHg | 0.6 ± 0.2 mmHg |
| Pressure | mmHg | | |
| (mean ± SE) | | | |
| Intragastric | 3.3 ± 0.9 | 4.9 ± 1.9 mmHg | 5.1 ± 0.0 mmHg |
| pressure | mmHg | | |
| (mean ± SE) | | | |

*p < 0.005 when compared to normal subjects

### Example IX

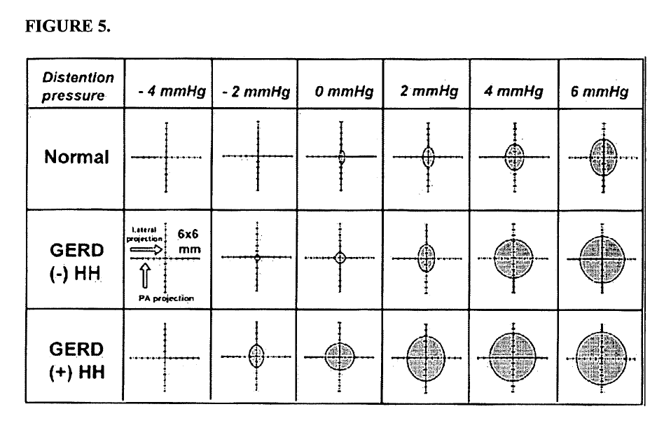

This Example describes the EGJ opening during low-pressure distension as measured in some embodiments of the present invention. The smallest EGJ opening aperture during deglutitive relaxation occurred at the level of the diaphragmatic hiatus in all subjects. Radial asymmetry was noted in the normal subjects during pressure distention with the lateral diameter being greater than the PA (FIG. 5). The GERD patients with and without HH have a more symmetrical EGJ opening, especially during greater distention pressure settings.

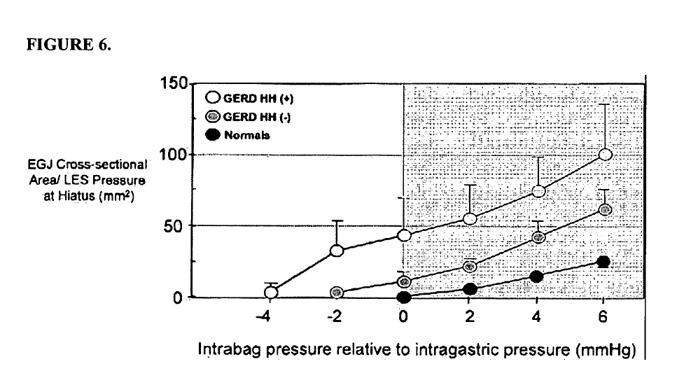

By ANOVA analysis, EGJ cross-sectional opening areas at pressures ≦0 mmHg (intragastric pressure) were significantly greater in HH compared to both NL and NHH patients (P<0.05) (FIG. 6). At pressures >0 mmHg, EGJ cross-sectional opening areas were significantly greater in the HH patients compared to the NHH patients (P<0.01) and also in the NHH patients compared to NL (P<0.0001) (FIG. 6). As another indication of the altered compliance of the EGJ in both GERD groups, the slope of the EGJ cross-sectional area/distention pressure relationship in the HH and NHH patients was at least twice that of NL subjects (HH=0.09 cm²/mmHg, NHH=0.08 cm²/mmHg, NL=0.03 cm²/mmHg) (FIG. 6).

### Example X

This Example describes the simulation of air and water flow through the EGJ as measured in some embodiments of the present invention. Extrapolating from FIG. 6, the mean opening apertures of the NL NHH and HH patient groups at a 4 mmHg distention pressure was approximately 13, 40, and 75 mm2 respectively. These diameters are roughly equivalent to the cross sectional areas of 4, 7, and 10 mm ID tubing respectively (13, 38, and 79 mm² respectively). Simulated flow rates of air and water through tubing of sizes encompassing these cross-sectional dimensions and length of 1 cm are shown in Table 3. Evident in the table, flow of air exceeds the technical specifications of the barostat through tubing sizes greater than 2 mm. Hydrostat estimates of water flow, however, are much more modest and reveal that flow is increased about threefold in GERD patients without hiatus hernia and twice again in GERD patients with hiatus hernia.

TABLE 3
Simulated flow rates of water and air across the EGJ using a
hydrostat or barostat and short lengths of polyurethane tubing.
The diameter of the tubing used to model each group simulates
cross-sectional area observed with distention pressures of 4 mmHg.

| | | Water Flow | Air flow |
|---|---|---|---|
| Tube size ID (mm) | Area mm² | ml/sec | ml/sec |
| 2 mm | 3 | .7 | 40 |
| 3 mm | 7.1 | 1.5 | 83† |
| 4 mm- Normal Subjects* | 12.6 | 2.8 | 154† |
| 6 mm | 28.3 | 5.5 | 303† |
| 7 mm- GERD without | 38.5 | 8.5 | 468† |
| hiatus hernia* | | | |
| 8 mm | 50 | 11.1 | 610† |
| 10 mm- GERD with | 78.5 | 19.5 | 1073† |
| hiatus hernia* | | | |

*Diameter of tubing simulating cross-sectional area of each study group with distention pressures of 4 mmHg.
†Given the fact that 57 ml/sec was the greatest flow rate attainable with the barostat, air flow rates were extrapolated from liquid flow rates using a liquid:air viscosity ratio of 55:1.

All publications and patents mentioned in the above specification are herein incorporated by reference. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A system for imaging a junction between body areas comprising,
a) a barostat component comprising a radioopaque imaging agent;
b) a bag component connectable to said barostat via tubing, said bag component configured to receive said imaging agent through said tubing, said bag further configured to engage said junction; and
c) an imaging component configured to measure cross-sectional area of said junction as a function of pressure within said bag.

2. The system of claim 1, wherein said barostat component provides said imaging agent to said bag component under a predetermined pressure such that said bag assumes said pressure.

3. The system of claim 1, wherein said bag component is made of polyethylene.

4. The system of claim 1, further comprising a manometric catheter configured to measure pressure within said bag component.

5. The system of claim 1, further comprising an endoscopic tube.

6. The system of claim 1, further comprising a thermal energy component selected from the group consisting of a laser energy component, a radiofrequency energy component, a microwave energy component, and an ultrasound energy component.

7. The system of claim 6, wherein said thermal energy component is configured to delivery thermal energy in a manner perpendicular to the axis of said bag.

8. A method of analyzing a body area of a subject, comprising:
a) providing the system of claim 1; and
b) contacting said body area with said bag component.

9. The method of claim 8, wherein said body area comprises an esophogastric junction.

10. The method of claim 8, wherein said body area comprises a sphincter muscle.

11. The method of claim 8, further comprising the step of c) measuring a cross-sectional area of said junction as a function of pressure within said bag.

12. The method of claim 10, further comprising the step of d) diagnosing a disease or condition based on data obtained from said system.

13. The method of claim 12, wherein said disease or condition is GERD.

14. The method of claim 12, wherein said disease or condition is GERD with hiatus hernia.

15. The method of claim 12, wherein said disease or condition is GERD without hiatus hernia.

16. The method of claim 12, wherein said disease or condition is female stress urinary incontinence.

17. The method of claim 12, wherein said disease or condition is fecal incontinence.

18. The method of claim 8, further comprising the step of monitoring a medical procedure by monitoring said imaging component.

19. The method of claim 19, wherein said medical procedure comprises a surgery.

20. The method of claim 18, wherein said surgery comprises endoscopic lithotripsy.

21. The method of claim 18, wherein said medical procedure comprises a drug therapy.

22. The method of claim 21, wherein said drug therapy comprises application of a drug selected from the group consisting of an anti-cancer agent, ranitidine, cimetidine, famotidine, nizatidine, omeprazole, lansoprozole, rabeprazole, esomeprazole, and metoclopramide.

23. The method of claim 18, wherein said medical procedure comprises application of a thermal energy selected from the group consisting of laser energy, radiofrequency energy, microwave energy, and ultrasound energy.

24. A system for imaging a body area comprising,
a) a barostat component comprising a radioopaque imaging agent;
b) a bag component connectable to said barostat via tubing, said bag component configured to receive said imaging agent through said tubing, said bag further configured to engage said junction;
c) an imaging component configured to analyze said body area as function of pressure within said bag; and
d) a therapeutic component.

25. The system of claim 24, wherein said therapeutic component is a therapeutic drug.

26. The system of claim 24, wherein said therapeutic component provides a cooling component to reduce the temperature of said imaging agent.

27. The system of claim 24, wherein said therapeutic component is selected from the group consisting of laser energy, radiofrequency energy, microwave energy, and ultrasound energy.

28. The system of claim 27, wherein said system is configured for fiber-optic delivery of said laser energy.

29. The system of claim 28, wherein said laser energy is delivered at a range of about 70 to 110 degrees from the axis of said fiber-optic.

30. The system of claim 25, wherein said therapeutic drug is selected from the group consisting of an anti-cancer agent, ranitidine, cimetidine, famotidine, nizatidine, omeprazole, lansoprozole, rabeprazole, esomeprazole, and metoclopramide.

31. A method of treating a subject comprising:
a) providing the system of claim 27;
b) treating said subject with a thermal energy emitting component; and
c) monitoring said treating by detecting said imaging component.

32. The method of claim 31, wherein said subject suffers from or is suspected of suffering from a condition selected from the group consisting of GERD, female stress urinary incontinence, fecal incontinence, and cancer.
